(19) United States
(12) Patent Application Publication
(10) Pub. No.: US 2005/0246189 A1
(43) Pub. Date: Nov. 3, 2005

(54) System for determining medical resource utilization characteristics

(76) Inventors: Arnold Monitzer, Pullach im Isartal (DE); Bhanu Gouda, Greenbelt, MD (US); Vamsi Chemitiganti, Coatesville, PA (US)

Correspondence Address: Alexander J. Burke;Intellectual Property Department, 5th Floor, 170 Wood Avenue South, Iselin, NJ, 08830, US

(21) Appl. No.: 10/950,907

(22) Filed: Sep. 27, 2004

Related U.S. Application Data
(60) Provisional application No. 60/566,564, filed on Apr. 29, 2004.

(51) Int. Cl. G06F 17/60

(52) U.S. Cl. 705/1

(57) ABSTRACT

A system is interfaced with multiple different financial, clinical and inventory information systems that provide information for on-line analytical processing to provide resource usage characteristics. A system for determining characteristics of resource usage, includes an acquisition processor for automatically acquiring data representing information. The acquired information includes revenue received for a particular usage of a particular resource by a particular patient, operating cost of maintaining the resource, and an acquisition cost of the resource. A data analyzer processes the acquired information to determine a profit or loss attributable to the resource. A communication processor communicates a message to a remote unit indicating the profit or loss in response to user command.

This is a non-provisional application of provisional applications Ser. No. 60/566,564 by A. Monitzer et al. filed Apr. 29, 2004.

### FIELD OF THE INVENTION

This invention concerns a system and user interface for monitoring resource usage (e.g., of a medical device such as an MR imaging unit) and for determining cost and profitability of the resource.

### BACKGROUND INFORMATION

In order to optimize acquisition, deployment and usage of resources such as a medical device in a hospital, for example, it is necessary to accurately determine the true profit or loss attributable to a particular resource. This requires the accurate determination of the total costs and revenue attributable to an individual resource over a particular time duration. It is also desirable to be able to determine this information on a substantially immediate and real time basis to enable an accurate, current profit or loss determination to be made for a particular medical device upon user request. Accurate cost, revenue and profitability (or loss) information for a particular medical device facilitates device management and maximizing revenue, minimizing cost and optimizing profit of the medical device. The information also enables inventory management and identification of medical devices that are underused or overused as well as identification of the need for an additional device or a redundant device that may be eliminated.

There are a number of problems involved in accurately determining cost, revenue and profitability (or loss) information for a particular medical device or other resource at a particular time. Specifically, asset depreciation, cost, revenue and other relevant information may be inaccessible, or retained in remote different computer systems. Further, resource cost and revenue information may be subject to assessment or determinations made by third parties involving additional different computer systems and communications that delay determination of accurate cost and revenue data. Existing systems in supply chain management, product pricing and marketing and service payment reimbursement, for example, are concerned with optimization of cost but fail to determine true costs, payments, revenues and profitability. A system according to invention principles addresses the identified deficiencies and associated problems

### SUMMARY OF THE INVENTION

A system employs an on-line analytical processing (OLAP) compatible database to support creation of fact and dimensional tables including information automatically and seamlessly derived from, a hospital revenue management system (e.g. a Clinical and Financial Information System), an expense system (e.g. Ariba compatible system) and a medical device inventory management system. A system for determining characteristics of resource usage (such as actual, cost, revenue and profit or loss), includes an acquisition processor for automatically acquiring data representing information. The acquired information includes revenue received for a particular usage of a particular resource by a particular patient, operating cost of maintaining the resource, and an acquisition cost of the resource. A data analyzer processes the acquired information to determine a profit or loss attributable to the resource. A communication processor communicates a message to a remote unit indicating the profit or loss in response to user command.

### BRIEF DESCRIPTION OF THE DRAWINGS

FIG. 1 shows a system for providing resource usage characteristics, according to invention principles.

FIG. 2 shows a flowchart of a method used by the system of FIG. 1 for accessing resource usage characteristics, according to invention principles.

FIG. 3 shows a flowchart of a process for providing financial and other resource usage characteristics, according to invention principles.

### DETAILED DESCRIPTION OF INVENTION

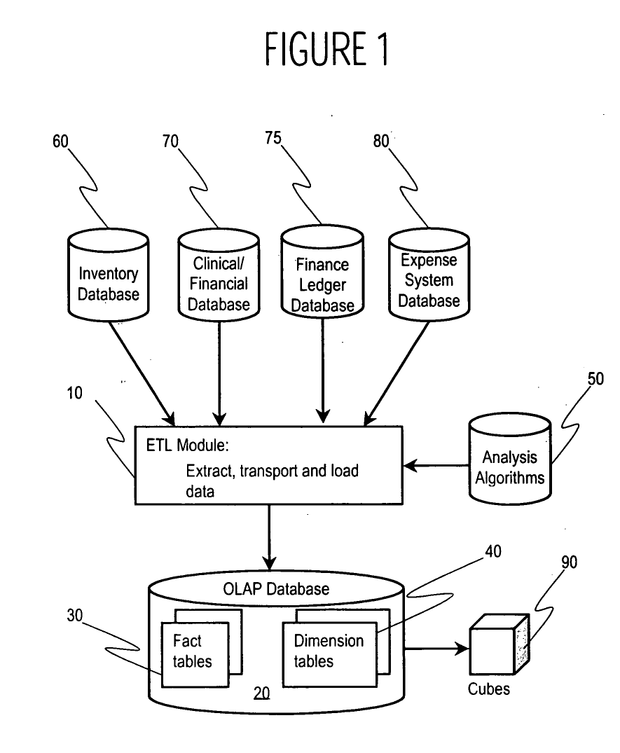

FIG. 1 shows a system including interfaces with multiple different financial, clinical and inventory information systems for automatically acquiring information for on-line analytical processing to provide resource usage characteristics such as cost, revenue and profitability. The system provides resource usage characteristics for a user selected time period or a particular instance of use. For this purpose, the system employs an on-line analytical processing (OLAP) compatible database that supports creation of fact and dimensional tables containing information automatically and seamlessly derived from, a hospital revenue management system (e.g. a Clinical and Financial Information System), an expense system (e.g., Ariba compatible system) and a medical device inventory management system.

The inventors have advantageously recognized that medical device (and other resource) utilization characteristics may be accurately determined by a system that integrates and configures particular information systems. In a hospital, for example, the system advantageously integrates device management related systems with a hospital revenue management system and enables determination of utilization characteristics including accurate cost, revenue and profitability of a particular medical device (e.g., a magnetic resonance (MR), X-ray, computerized tomography (CT) scan or other imaging device). The determination of accurate revenue and cost data for usage of a particular medical device is impeded by the fact that data required to determine an individual cost or revenue figure may be located within multiple different processing systems. Further, these different processing systems may be incompatible and may contain required cost or revenue information in different record formats accessible using different parameters. The data also may be derived at different times and may be available after varying periods of time delay.

The system performs cost optimization by determining final reimbursement amounts received from an insurance company and other payers for services performed for a patient using a medical device (or other resource). A final revenue payment made in reimbursement for a specific service rendered to a particular patient using a medical device typically depends on the terms of a particular contract existing between an insurance company and a health care provider. Medical insurance contract terms vary for different patients since patients participate in different health care plans with different insurance companies. Hospital revenue management systems (e.g. Clinical Information systems and Financial systems) store contract information. Hospital revenue management systems also process financial transactions including claims between a health care provider and an insurance company. The system interfaces with Hospital revenue management systems, clinical and inventory information systems for automatically acquiring information and determining true cost of a medical device and payments received for a medical device for individual services performed for patients. For this purpose, the system automatically accesses accounts in a Hospital revenue management system and other financial systems of a healthcare provider.

The system employs the automatically acquired current, accurate information to determine optimized utilization characteristics of a medical device such as true cost, revenue and profitability of a medical device in a predetermined time period or for a particular instance of use. These characteristics enable a user to optimize how and when a medical device is deployed, as well as how the device is used, including the frequency of its use and the type of services it is used to provide. The system loads current, accurate data derived from, a hospital revenue management system (such as payments received for services rendered on imaging modalities) and from an expense system (such as depreciation of capital expenditures for imaging modalities) and also from a financial system (such as operational expenses for imaging modalities). The system advantageously automates determination of optimized utilization characteristics through its integration with a hospital revenue management system providing accurate and up-to-date device costs.

The system creates fact tables and dimensional tables supporting online analytical processing and organization of data in a cubic structure, for example. This structure facilitates search and search refinement (e.g., drilling down, and slice and dice type search) for the purpose of profitability analysis. In order to make an accurate business decision in a hospital, for example, the system advantageously creates and builds fact and dimensional tables using information stored in, a hospital revenue management system, an expense system (financial system) and inventory management system. The system employs a module that extracts information from online transactional databases or copies thereof and transfers and modifies the data using analysis algorithms to create fact tables and dimensional tables in an online analytical processing database (OLAP database).

An executable application comprises code or machine readable instruction for implementing predetermined functions including those of an operating system, healthcare information system or other information processing system, for example, in response to user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A data analyzer comprises a processor for processing data by performing combinatorial, algebraic, logical and other analysis functions including financial accounting functions. A database is one or more centralized data repository or multiple distributed data repositories, storing records and associated data supporting data search, location and extraction.

In the FIG. 1 system, extraction module (processor) 10 is interfaced with multiple different financial, clinical and inventory information systems for automatically acquiring information for on-line analytical processing to provide resource (e.g., medical device) usage characteristics such as cost, revenue and profitability. Specifically, extraction module 10 bidirectionally communicates with inventory database 60, clinical and financial information database 70, financial ledger system database 75 and expense system database 80 for automatically accessing and acquiring information for on-line analytical processing. Inventory database 60 includes information identifying an inventory of medical devices of a health care provider organization. Inventory database 60 maintains records that automatically track changes in the current inventory of medical devices of a healthcare provider organization. It does this by employing a plug-and-track identification system in which, upon connection of a device to a network and powering the device, identification and location information of the device is automatically communicated via the network for storage in database 60. Such communication may be wired or wireless or a combination of both. Inventory database 60 maintains a record for each medical device including a unique equipment identification code, equipment type and manufacturer information as well as equipment usage data (including usage history).

Clinical and financial information database 70 (comprising a hospital revenue management system, for example) maintains records that track services rendered to a patient including date and time stamps identifying time and date of medical device usage in providing a particular service and a current status of reimbursement and payment for the particular service. Financial ledger system database 75 (such as an SAP, or Peoplesoft compatible system, for example) stores summarized ledger data. Expense system database 80 maintains records that track expense information. The expense information identifies, purchase cost and date of purchase of specific items of a medical device inventory, medical device service and operational fees and costs as well as capital (purchase) cost depreciation for individual medical devices.

Extraction module (ETL) 10 automatically acquires data from tables stored in inventory database 60, clinical and financial information database 70, financial ledger database 75, and expense system database 80. Module 10 automatically collates, transforms and communicates acquired data for storage in OLAP database 20 and creates fact tables 30 and dimension tables 40. Module 10 employs analysis algorithms 50 in modifying and processing data acquired from databases 60-80 for transfer to OLAP database 20. Analysis algorithms 50 also create fact tables 30 and dimensional tables 40 in online analytical processing database 20. Module 10 employs analysis and visualization applications (such as Cognos and Microsoft Analysis applications) to generate cubes 90 comprising data representing organized, structured information for display to a user in a display image. The cubic structured information includes device inventory, time period, medical procedure and medical condition identification and selection information, for example. This facilitates user selection of search criteria for implementing a search to provide medical device profitability related characteristics sorted by particular device, medical procedure, patient medical condition and other parameters. As a result data cubes 90, presented to a user in a display image, facilitate user initiated data mining, and hierarchical search and analysis. Cognos visualizer applications create sophisticated visual reports and display multiple measures simultaneously to communicate complex business data quickly and intuitively. Similarly, Microsoft Analysis applications provide data analysis supporting on-line analytical processing of data in fact tables 30 and dimension tables 40 to support data mining of database 20.

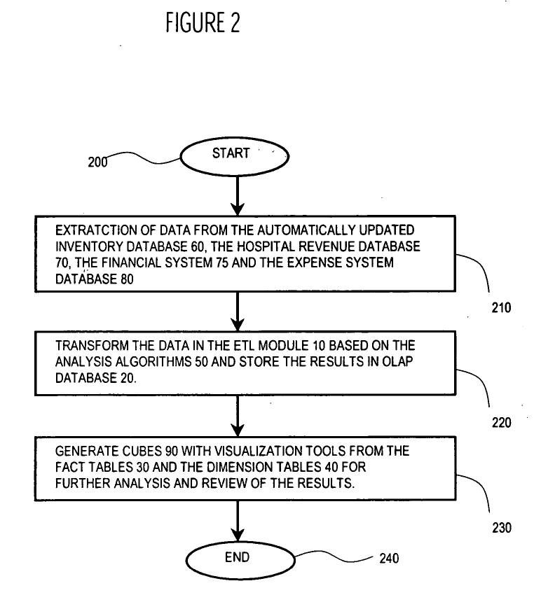

FIG. 2 shows a flowchart of a method used by extraction module 10 (FIG. 1) of the system of FIG. 1 for accessing resource usage characteristics. In step 210, following the start at step 200, module 10 extracts data from automatically updated inventory database 60, clinical information database 70, financial ledger database 75, and expense system database 80. Module 10 in step 220 transforms the extracted data using analysis algorithms 50 and stores the modified data in OLAP database 20. In step 230 module 10 generates cubes 90 with data from fact tables 30 and dimension table 40 using analysis applications. Data cubes 90 includes search indices, keys and other data facilitating search through database 20 for desired inventory, cost revenue and other resource usage characteristics. Data cubes 90 may also include data representing a visual presentation of device inventory, time period, medical procedure and medical condition identification and selection information This facilitates user selection of search criteria for implementing a search to provide medical device profitability related characteristics sorted by particular device, medical procedure patient medical condition and other parameters. Alternatively, the data cubes may also include data representing a display image showing data indicating medical device profitability related characteristics sorted by particular device, medical procedure patient medical condition and other parameters, in response to user command. The process of FIG. 2 terminates at step 240.

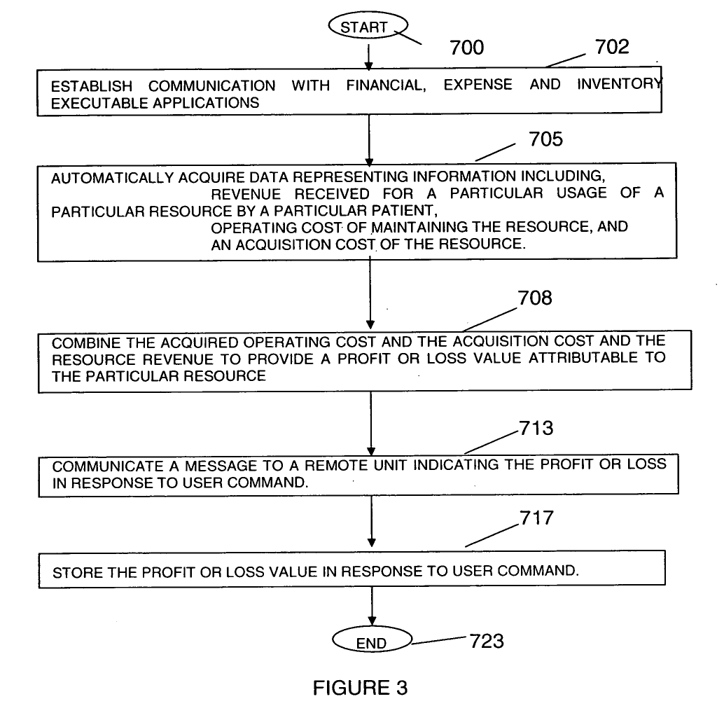

FIG. 3 shows a flowchart of a process employed by module 10 (FIG. 1) for providing financial and other resource usage characteristics. Module 10 in step 702 following the start at step 700, establishes communication with executable applications managing remote inventory database 60, clinical information database 70, financial ledger database 75, and expense system database 80. Module 10 establishes communication using predetermined data format and communication protocol information derived from a communication data map in unit 10 associating communication data format and protocol with a particular corresponding database (of databases 60-80). Module 10 in step 705 automatically acquires data representing information including, revenue received for a particular usage of a particular medical device (resource) by a particular patient such as an MR imaging unit. Similarly, module 10 automatically acquires data representing information including operating cost of maintaining the medical device and an acquisition cost of the medical device, attributable to the particular usage of the medical device by the particular patient. Specifically, module 10 accumulates data representing revenue received for a particular usage of a particular medical device by a particular patient for individual episodes of use of the medical device during a predetermined period to provide a total revenue value generated by the medical device for the predetermined period.

The received revenue for an individual particular usage of the particular medical device by the particular patient comprises an actual reimbursement sum received from an organization for the particular usage in response to a reimbursement claim for reimbursement made to the organization. Module 10 accumulates received revenue data for usage of a particular medical device by multiple different patients for individual episodes of use of the medical device in response to reimbursement claims made to a multiple different organizations. The operating cost of maintaining the medical device includes at least one of, (a) a cost of services to maintain the medical device, (b) a cost of parts to maintain the medical device and (c) a cost attributed to associated overhead expenses for maintaining the medical device.

In step 708 module 10 combines the operating cost and the acquisition cost and the resource revenue to provide a profit or loss value attributable to the particular medical device. Module 10 subtracts the operating cost and the acquisition cost from the medical device revenue to provide the profit or loss attributable to the medical device, for example. In other embodiments, module 10 combines the operating cost and the acquisition cost and the resource revenue using other data in a more complex manner (as known) to account for depreciation of acquisition (capital) cost, taxation, lease or rental arrangements, deferral of cost, deferral of revenue, loan repayments and other factors in order to provide a profit or loss value attributable to the particular medical device. In response to user command unit IQ, in step 713, communicates a message to a remote unit indicating the profit or loss value determined in step 708 and stores the value in step 717. The process of FIG. 3 terminates at step 723.

The system and processes presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and process of FIGS. 1-3 may be implemented in hardware, software or a combination of both. The system advantageously combines automatic inventory discovery providing medical device utilization data comprising accurate financial information from a financial system, hospital revenue system and expense system to determine true cost and profitability of each medical device tracked in the inventory system. The system generates fact tables and dimension tables from data extracted and transformed from inventory database, hospital revenues system database, and expense system database for the profitability analysis using cube structured data, for example. The system is usable in a wide variety of environments not just a healthcare environment.

1. A system for determining characteristics of resource usage, comprising:
an acquisition processor for automatically acquiring data representing information including,
revenue received for a particular usage of a particular resource by a particular patient,
operating cost of maintaining said resource, and
an acquisition cost of said resource;
a data analyzer for processing said acquired information to determine a profit or loss attributable to said resource; and
a storage processor for storing data representing said profit or loss.

2. The system according to claim 1, wherein
said resource comprises a medical device and
said data analyzer accumulates data representing revenue received for a particular usage of a particular resource by a particular patient for individual episodes of use of said medical device during a predetermined period to provide a total revenue generated by said medical device for said predetermined period.

3. The system according to claim 2, wherein
said received revenue for said particular usage of said particular medical device by said particular patient comprises an actual reimbursement sum received from an organization for said particular usage in response to a reimbursement claim for reimbursement made to said organization and
said data analyzer accumulates received revenue data for usage of a particular medical device by a plurality of different patients for individual episodes of use of said medical device in response to reimbursement claims made to a plurality of different organizations.

4. The system according to claim 2, wherein
said operating cost of maintaining said medical device includes at least one of, (a) a cost of services to maintain said medical device, (b) a cost of parts to maintain said medical device and (c) a cost attributed to associated overhead expenses for maintaining said medical device.

5. The system according to claim 2, wherein
said acquisition processor is interfaced with a financial executable application enabling automatic receiving and accumulation of revenue data for usage of a particular medical device by a plurality of different patients for individual episodes of use of said medical device.

6. The system according to claim 2, wherein
said data analyzer combines said-operating cost and said acquisition cost and said medical device revenue to provide-said profit or loss attributable to said medical device.

7. The system according to claim 6, wherein
said data analyzer subtracts said operating cost and said acquisition cost from said medical device revenue to provide said profit or loss attributable to said medical device.

8. The system according to claim 1, wherein
said data analyzer combines said operating cost and said acquisition cost and said medical device revenue to provide said profit or loss attributable to said resource in a manner account for at least one of, (a) depreciation, (b) taxation, (c) lease or rental arrangements, (d) deferral of cost, (e) deferral of revenue and (f) loan repayments.

9. The system according to claim 1, wherein
said acquisition processor automatically establishes communication with at least one repository using predetermined communication protocol data to acquire said information.

10. The system according to claim 1, wherein
said acquisition processor converts said acquired information to a data format suitable for processing by said data analyzer to determine said profit or loss attributable to said resource.

11. A method for determining characteristics of resource usage, comprising the activities of:
automatically acquiring data representing information including,
revenue received for a particular usage of a particular resource by a particular patient,
operating cost of maintaining said resource, and
an acquisition cost of said resource;
processing said acquired information to determine a profit or loss attributable to said resource; and
communicating a message to a remote unit indicating said profit or loss in response to user command.

12. A system for determining characteristics of resource usage, comprising:
an acquisition processor for automatically acquiring data representing information including,
revenue received for a particular usage of a particular resource by a particular patient,
operating cost of maintaining said resource attributable to said particular usage of said particular resource by said particular patient, and
an acquisition cost of said resource attributable to said particular usage of said particular resource by said particular patient;
a data analyzer for processing said acquired information to determine a profit or loss attributable to said resource for said particular usage of said particular resource by said particular patient; and
a communication processor for communicating a message to a remote unit indicating said profit or loss in response to user command.

13. A system for determining characteristics of medical device usage, comprising:
an acquisition processor for automatically acquiring data representing information including,
revenue received for a particular usage of a particular medical device by a particular patient,
operating cost of maintaining said medical device and
an acquisition cost of said medical device; and
a data analyzer for,
accumulating data representing revenue received for a particular usage of a particular resource by a particular patient for individual episodes of use of said medical device during a predetermined period to provide a total revenue generated by said medical device for said predetermined period and
processing said acquired information to determine a profit or loss attributable to said medical device.

14. The system according to claim 13, wherein
said received revenue for said particular usage of said particular medical device by said particular patient comprises an actual reimbursement sum received from an organization for said particular usage in response to a reimbursement claim for reimbursement made to said organization.

15. The system according to claim 13, wherein
said data analyzer accumulates received revenue data for usage of a particular medical device by a plurality of different patients for individual episodes of use of said medical device in response to reimbursement claims made to a plurality of different organizations.

16. A system for determining financial characteristics of medical device usage, comprising:
an acquisition processor in communication with a financial executable application, for automatically acquiring data representing information including,
revenue received for a particular usage of a particular medical device by a particular patient,
operating cost of maintaining said medical device and
an acquisition cost of said medical device;
a data analyzer for combining said operating cost and said acquisition cost and said resource revenue to provide a profit or loss value attributable to said particular medical device; and
a storage processor for storing said profit or loss value in response to user command.

17. The system according to claim 16, wherein
said acquisition processor accumulates, from said financial executable application, data representing revenue received for a particular usage of said particular medical device by a particular patient for individual episodes of use of said particular medical device.

18. The system according to claim 16, wherein
said individual episodes of use of said medical device occur during a predetermined period and
said data analyzer provides a total revenue generated by said particular medical device for said predetermined period.

19. The system according to claim 16, wherein
said data analyzer subtracts said operating cost and said acquisition cost from said particular medical device revenue to provide said profit or loss attributable to said particular medical device.

20. The system according to claim 16, wherein
said received revenue is for a particular usage of said particular medical device by a particular patient.

21. The system according to claim 20, wherein
said particular usage of said particular medical device by said particular patient comprises an actual reimbursement sum received from an organization for said particular usage in response to a reimbursement claim for reimbursement made to said organization.

22. A method for determining characteristics of medical device usage, comprising the activities of:
automatically acquiring data representing information including,
revenue received for a particular usage of a particular medical device by a particular patient,
operating cost of maintaining said medical device and
an acquisition cost of said medical device; and
accumulating data representing revenue received for a particular usage of a particular resource by a particular patient for individual episodes of use of said medical device during a predetermined period to provide a total revenue generated by said medical device for said predetermined period; and
processing said acquired information to determine a profit or loss attributable to said medical device.
